(19) United States
(12) Patent Application Publication
(10) Pub. No.: US 2014/0181086 A1
(43) Pub. Date: Jun. 26, 2014

(54) SYSTEM AND METHOD OF PERFORMING A FACETED SEARCH

(71) Applicant: Dropbox, Inc., San Francisco, CA (US)

(72) Inventors: Akhil Wable, San Francisco, CA (US); Aditya Agarwal, San Francisco, CA (US); Ruchi Sanghvi, San Francisco, CA (US); Joshua Jenkins, San Francisco, CA (US)

(21) Appl. No.: 13/827,129

(22) Filed: Mar. 14, 2013

Related U.S. Application Data
(60) Provisional application No. 61/745,527, filed on Dec. 21, 2012.

(51) Int. Cl. G06F 17/30

(52) U.S. Cl. CPC G06F 17/30864
USPC 707/722

(57) ABSTRACT

A content management system that enables a member of a service to search for other members whose group profiles satisfy one or more search criteria is disclosed. The system further enables the member to select one or more of the members whose profile satisfies the search criteria, and facilitates communication between the member and the selected members. Thus, the member may send a communication to all members whose profiles satisfy the search criteria, or to a subset of those members whose profiles satisfy the search criteria. The communication may be an e-mail, an invitation, a chat message, a private positing on a public message board, a text message, or any other suitable type of communication.

### CLAIM OF PRIORITY

This application claims priority under 35 U.S.C. §119(e) to the filing date of U.S. Provisional Patent Application No. 61/745,527, filed Dec. 21, 2012, entitled, “A System And Method Of Performing A Faceted Search,” which is incorporated herein by reference in its entirety.

### BACKGROUND

A number of web-based or cloud-based services allow users to collaborate, share information, and join different groups that cater to their interests. For example, social networking services allow users to connect via “friends” or “connections.” Likewise, cloud-based cross-platform synchronization systems allow users to connect by sharing specific files or groups of files. In either service, finding users, groups of users, or specific files can be laborious because current search methods are archaic.

Current searching methods require a user to type in a search term and select search filtering criteria by checking boxes (or other similar means) that then limit the search results by facet (e.g., “company,” “name,” or “school”). In other searching methodologies, the user must understand a complicated search nomenclature (e.g., Boolean type searching) and enter one or more complicated search strings to located information stored in a data set. Some existing searching methods suggest search terms as a user types a term in a search box, but they are limited to the facet associated with the search box chosen by the user. The present disclosure recognizes and addresses the foregoing considerations, and others, of prior art system and methods.

### SUMMARY

A computer-implemented method, according to various embodiments, may provide a user of a service with the ability to facilitate communications between a particular user in a group and one or more other users in the group. In various embodiments, the method may include receiving a search term from a user and searching one or more data sets for one or more suggested search terms. The suggested search terms may contain the search term received from the user and may be associated with one or more system-designated facets. The method may then display the suggested search term(s) and the associated system-designated facets as suggested search term-facet combinations. The method may allow the user to select a suggested search term-facet combination. In response to the user selecting a suggested search term-facet combination, the method may initiate a search of a second data set based on the selected search term-facet combination.

A system, in various embodiments, for searching a data set may include at least one processor, memory operatively coupled to the at least one processor, and a second data set stored in memory. The processor may be configured to receive a search term from a user and search one or more data sets for the suggested search terms that contain the received search term and associated system-designated facets. The processor may also be configured to rank and display the suggested search terms and their associated system-designated facets as suggested search term-facet combinations. The processor may be configured to receive, from the user, a selection of one of the displayed search term-facet combinations and initiate a search of a second data set based on the selected search term-facet combination.

A system, in various embodiments, for performing a search may include at least one processor and a display that is operatively coupled to the at least one processor (hereinafter “the processor”). One or more data sets may be operatively coupled to the processor. The Processor may be configured to receive a search term from a user and search one or more data sets for entries that contain the received search term and that are associated with one of a plurality of system-designated facets. The processor may be configured to form a suggested search term-facet combination by pairing each entry that contains the received search term with the system-designated facet that is associated with the entry. The processor may also be configured to display the suggested search term-facet combinations and initiate a search of a second data set that is operatively coupled to the processor based on a selected one of the displayed search term-facet combinations.

### BRIEF DESCRIPTION OF THE DRAWINGS

Various embodiments of a computer system for a social networking site that facilitates communication between a particular member of a group and a subset of members of the group are described below. In the course of this description, reference will be made to the accompanying drawings, which are not necessarily drawn to scale, and wherein:

FIG. 1 shows a block diagram of a social networking system according to a particular embodiment;

FIG. 2 shows a block diagram of a computer that is suitable for use within the social networking system;

FIG. 3 shows a screen display according to a particular embodiment that shows Member Management and Group Details portions of a page on a social networking site according to a particular embodiment;

FIG. 4 shows a screen display according to a particular embodiment that shows a profile template according to a particular embodiment. The profile template is shown within the context of an administration panel that may be used to modify the fields that are included within a particular group profile;

FIG. 5 shows a screen display according to a particular embodiment that shows a home page for a group on the social networking system of FIG. 1;

FIG. 6 shows a screen display according to a particular embodiment that shows a members page for the group whose home page is shown in FIG. 5;

FIG. 7A shows a screen display of a user's member page for use in conjunction with the group whose home page is shown in FIG. 5;

FIG. 7B shows a screen display of the user member page of FIG. 7A in an edit mode;

FIGS. 8A-8E show screen displays according to a particular embodiment that shows an initial search of the members of the group whose home page is shown in of FIG. 5;

FIG. 9 shows a screen display according to a particular embodiment that shows a search on a secondary search term;

FIG. 10 shows a screen display according to a particular embodiment that shows a filtered listing of group members that is defined by the searches of FIGS. 8A-8E and 9; and

FIGS. 11-13 show flow charts depicting the operation of the web hosting system of FIG. 1.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Like numbers refer to like elements throughout.

System Overview

A system, according to various embodiments, enables a user to enter a search term in a search box. The system receives the search term and initiates a search in one or more data sets for entries that contain the entered search term and that are also associated with one or more system designated facets. The system may be configured to use each of the entries that contain the received search term to form suggested search term/facet combinations that may be used to search for entries in another data set. The system may be configured to form a suggested search term/facet combination by associating one or more entries found in the one or more data sets with a respective system designated facet that was associated with the entry in the one or more data sets. In various embodiments, the system may be configured to rank the suggested search term/facet combinations based on the number of times a suggested search term/facet combination is found in the one or more data sets. Thus, in some embodiments, the system will only present the top four ranked suggested search term/facet combinations to the user. Once the user selects one of the suggested search term/facet combinations, the system may be configured to search another data set for entries that contain the selected search term/facet combination. A system configured to carry out the above described search methodology is advantageous since it allows a user to enter a search term and receive one or more suggested search terms that are associated with a respective system designated facet. Such a system (1) speeds up a user's ability to formulate searches, (2) reduces the user's need to understand a particular system's search nomenclature and (3) may provide the user with suggested search terms that the user may not have formulated on their own.

The above described search methodology may be implemented in many different systems. For example, according to various embodiments, the above described search methodology may be implemented in a system that is adapted for providing a social networking site that allows users to join and interact with different groups of other users. Particular user groups may, for example, be formed based upon the personal or professional interests of the users, the users' educational backgrounds, or any other suitable criteria. Examples of social networking sites on which various methods described herein may be used include Facebook®, Twitter®, MySpace®, LinkedIn®, and any other social networking site. Moreover, the above described search methodology may be used in any type of system that allows a user of the system to search for data contained in a data set. Other examples of systems include a synchronized file system such as the Dropbox™ Service of Dropbox, Inc. of San Francisco, Calif.

In various embodiments, the above described search methodologies allow a user to search using free text searching that allows users to search for other members based on information included within user profiles for members on the site. By searching on specific fields from within the users' profiles, a user may filter the member group down to a subgroup of members that meet certain criteria important to the searcher. For example, a user may begin to type in the search term “Emory.” As the user types in “Em” the system may begin to suggest search terms and associated facets that may be system designated. The system may suggest search terms/facet designations including “Emory Jones—Name,” “Emory University—School,” and “Emersion, Inc.—Company.” The user can then select a suggested search term/facet combination for the system to use to perform a search in a data set that contains relevant information (e.g., in the case of a social networking site, member profile information to find members whose profiles contain the selected search term/facet combination).

Exemplary Technical Platforms

As will be appreciated by one skilled in the relevant field, the present invention may be, for example, embodied as a computer system, a processor configured to carry out a method, or a computer program product. Accordingly, various embodiments may take the form of an entirely hardware embodiment or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each element of the block diagrams and/or flowcharts, and combinations of elements in the block diagrams and flowcharts, respectively, may be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, elements of either the block diagrams and/or flowcharts support combinations of mechanisms for performing the specified functions, combinations of steps for performing the specified functions, and program instructions for performing the specified functions. It should also be understood that each element of the block diagrams and/or flowcharts, and combinations of elements in the block diagrams and/or flowcharts, can be implemented by special purpose hardware-based computer systems that perform the specified functions or steps, or combinations of special purpose hardware and other hardware executing appropriate computer instructions.

Exemplary System Architecture

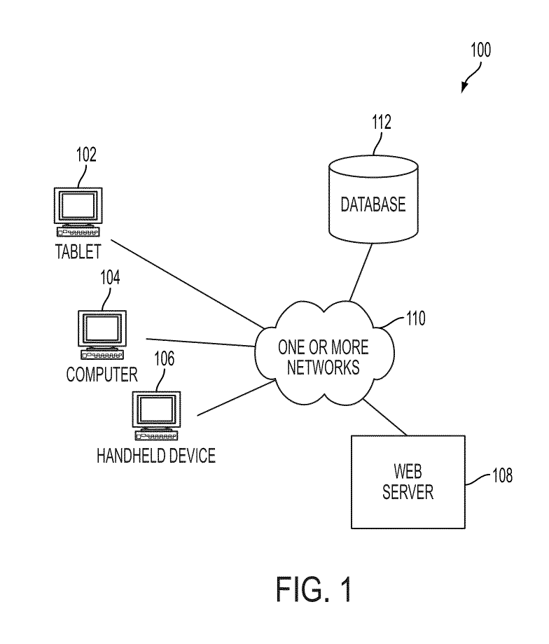

FIG. 1 is a block diagram of social networking system 100 according to a particular embodiment. As may be understood from this figure, social networking system 100 includes one or more remote computing devices such as tablet computer 102, desktop or laptop computer 104, or handheld computing device 106 (such as a cellular phone) that are in communication with web server 108 (which, for example, may be used to execute one or more modules as described below) and database 112 (which, for example, may be used to store the web content discussed below) via one or more computer networks 110. The one or more computer networks 110 may include any of a variety of types of wired or wireless computer networks such as the Internet. The communication link between web server 108 and database 112 may be, for example, implemented via a Local Area Network (LAN) or via the Internet.

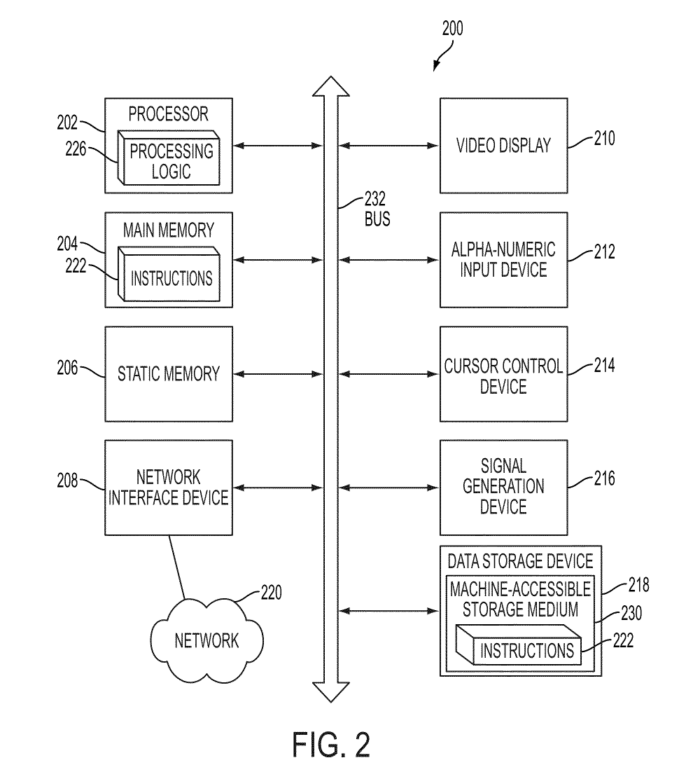

FIG. 2 illustrates a diagrammatic representation of computer 200 that can be used within social networking system 100, for example, as client computer (e.g., one of the client computers 102, 104, 106 shown in FIG. 1), or as server computer (e.g., the Web server 108 shown in FIG. 1).

In particular embodiments, computer 200 may be connected (e.g., networked) to other computers in a LAN, an intranet, an extranet, and/or the Internet. Computer 200 may operate in the capacity of a server or a client computer in a client-server network environment, or as a peer computer in a peer-to-peer (or distributed) network environment. Computer 200 may be personal computer (PC) 104, tablet PC 102, handheld device 106, Personal Digital Assistant (PDA), web appliance, or any computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

The exemplary computer 200 includes processing device 202, main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and data storage device 218, which communicate with each other via bus 232.

Processing device 202 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 202 may also be one or more special-purpose processing devices such as an application specific integrated circuit (ASIC), a field programmable gate array (FPGA), a digital signal processor (DSP), network processor, or the like. Processing device 202 may be configured to execute processing logic 226 for performing various operations and steps discussed herein.

Computer 200 may further include network interface device 208. Computer 200 also may include video display unit 210 (e.g., a liquid crystal display (LCD) or cathode ray tube (CRT)), alphanumeric input device 212 (e.g., a keyboard), cursor control device 214 (e.g., a mouse), and signal generation device 216 (e.g., a speaker).

Data storage device 218 may include non-transitory computer-accessible storage medium 230 (also known as a non-transitory computer-readable storage medium or a non-transitory computer-readable medium) on which is stored one or more sets of instructions (e.g., the method steps embodied in a search & communication module 222) embodying any one or more of the methodologies or functions described herein. Search & communication module 222 may also reside, completely or at least partially, within main memory 204 and/or within processing device 202 during execution thereof by computer 200, main memory 204 and processing device 202 also constituting computer-accessible storage media. Search & communication module 222 may further be transmitted or received over network 220 via network interface device 208.

While computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” shall also be understood to include any medium that is capable of storing, encoding or carrying a set of instructions for execution by the computer and that cause the computer to perform any one or more of the methodologies of the present invention. The term “computer-accessible storage medium” shall accordingly be understood to include, but not be limited to, solid-state memories, optical and magnetic media, etc.

### Exemplary System Operation

An explanation of the operation of the search methodologies of the present systems and methods are described herein with reference to a social networking site. However, it should be understood that the search methodologies may be used in any type of system that allows a user to search for data (e.g., a synchronized content management system).

When a user of a service (e.g., a social networking service) wants to communicate with a group of members that have certain attributes in common with the user, the user may search for members that contain one or more attributes (e.g., attended a certain school, work for a particular employer, and/or live in a particular city) and communicate with the subset of members whose user profile contains the one or more attributes. Thus, the service may allow users to send messages to a select subset of members of a group with accounts with the service.

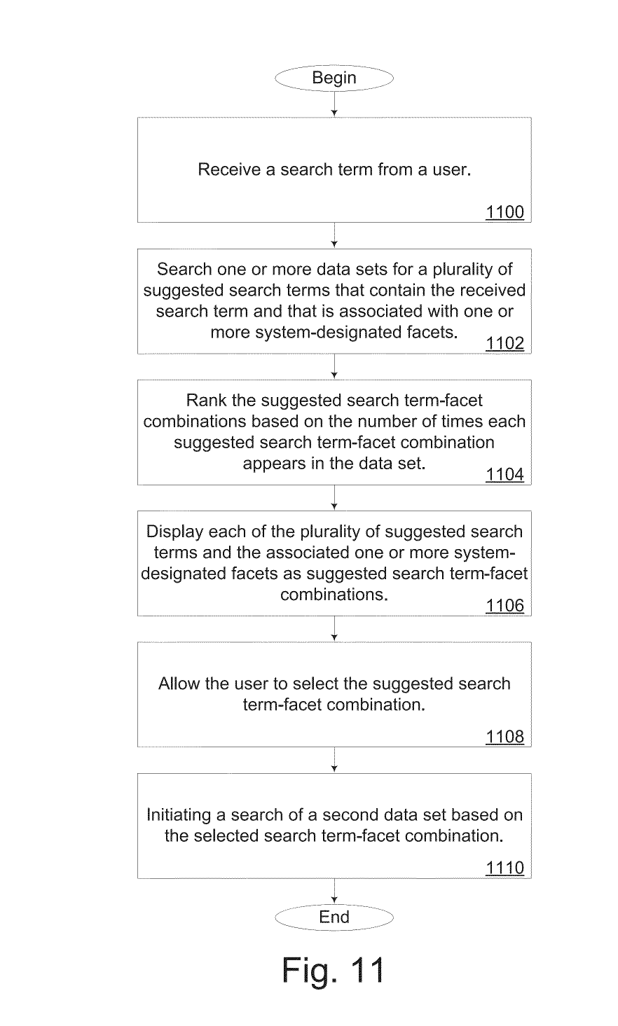

FIGS. 11, 12, and 13 depict exemplary methods for searching for a subset of members of a service whose profile contains certain search criteria. The system may receive a search term from a searcher and search one more data sets for data that contains the search term and that is associated with one or more system-designated facets. The system may then display one or more suggested search terms and the associated system-designed facets. The system may be configured to allow the user to select one of the suggested search term/facet combinations and then search another data set that contains member profile information. The system may then display the member profiles that contain the selected search term/facet combination and allow the user to select one or more of the profiles to send a private communication.

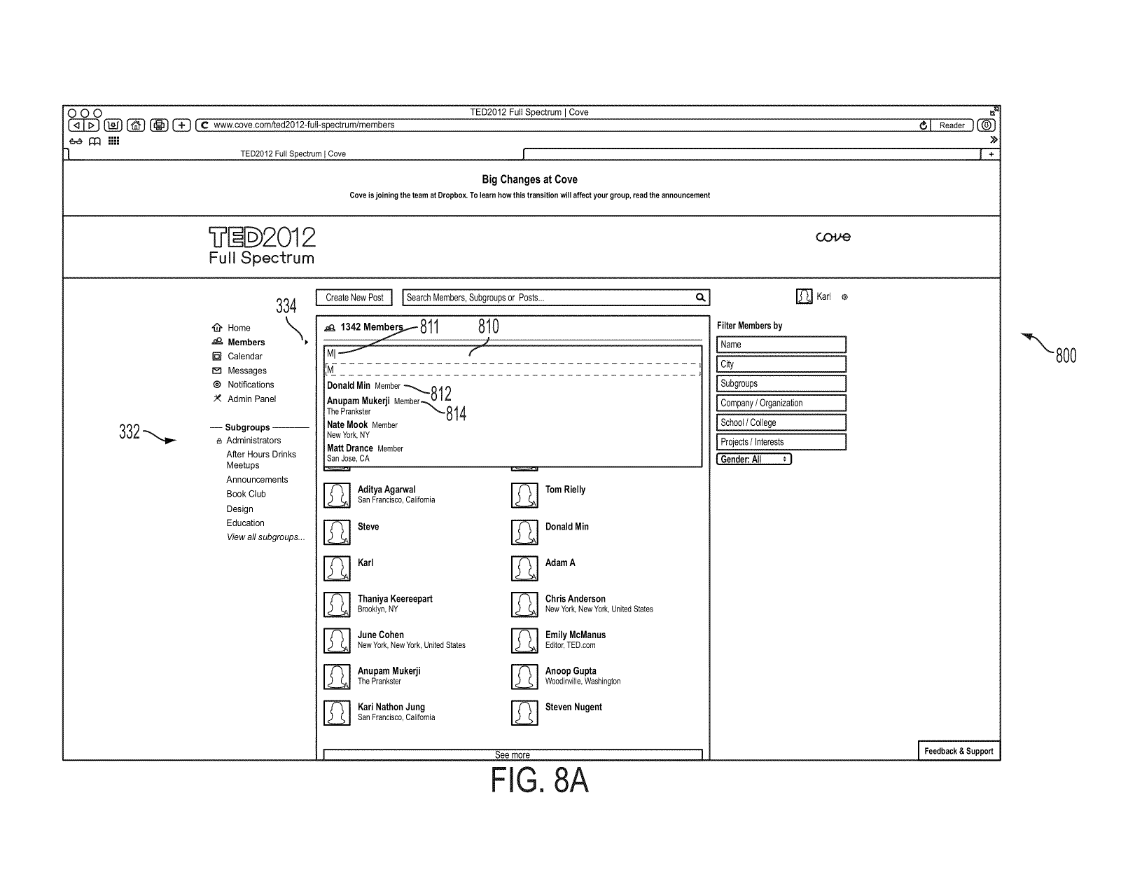

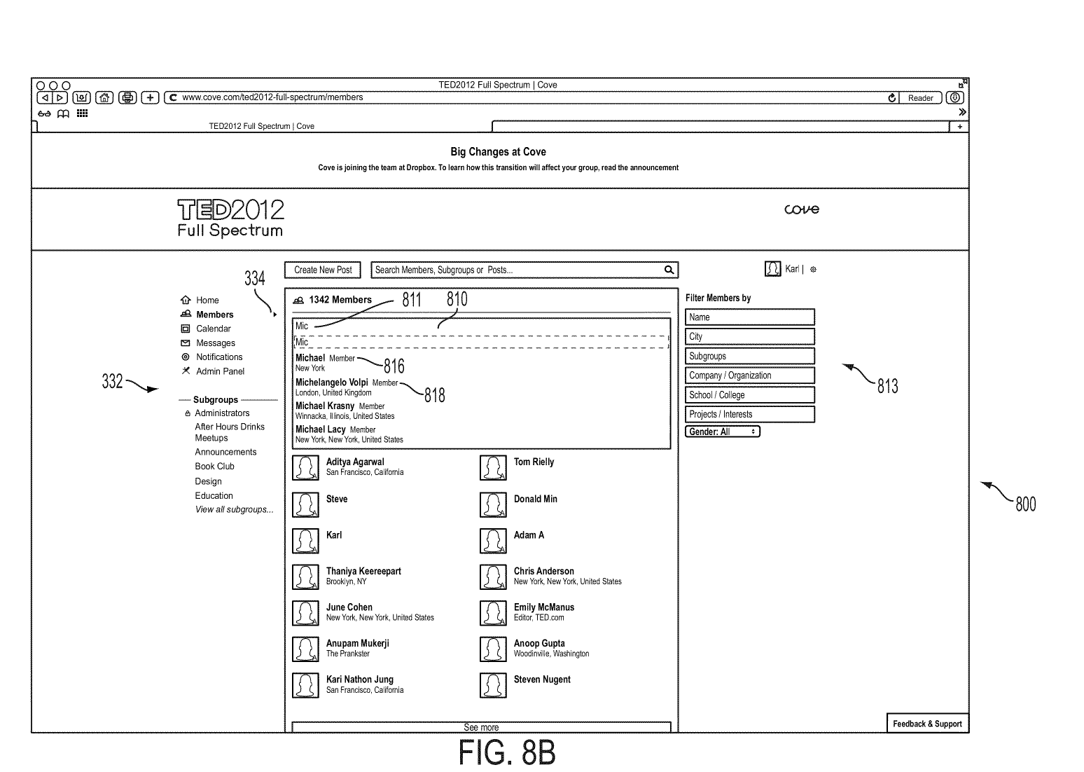

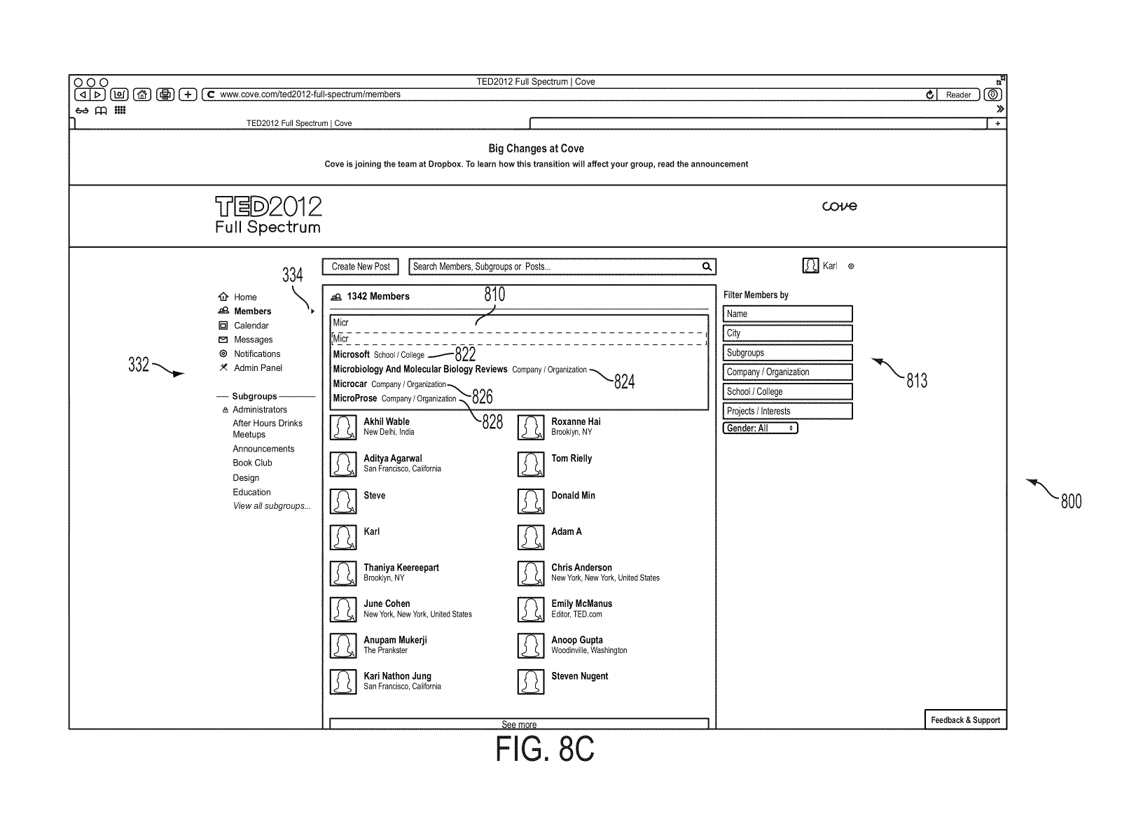

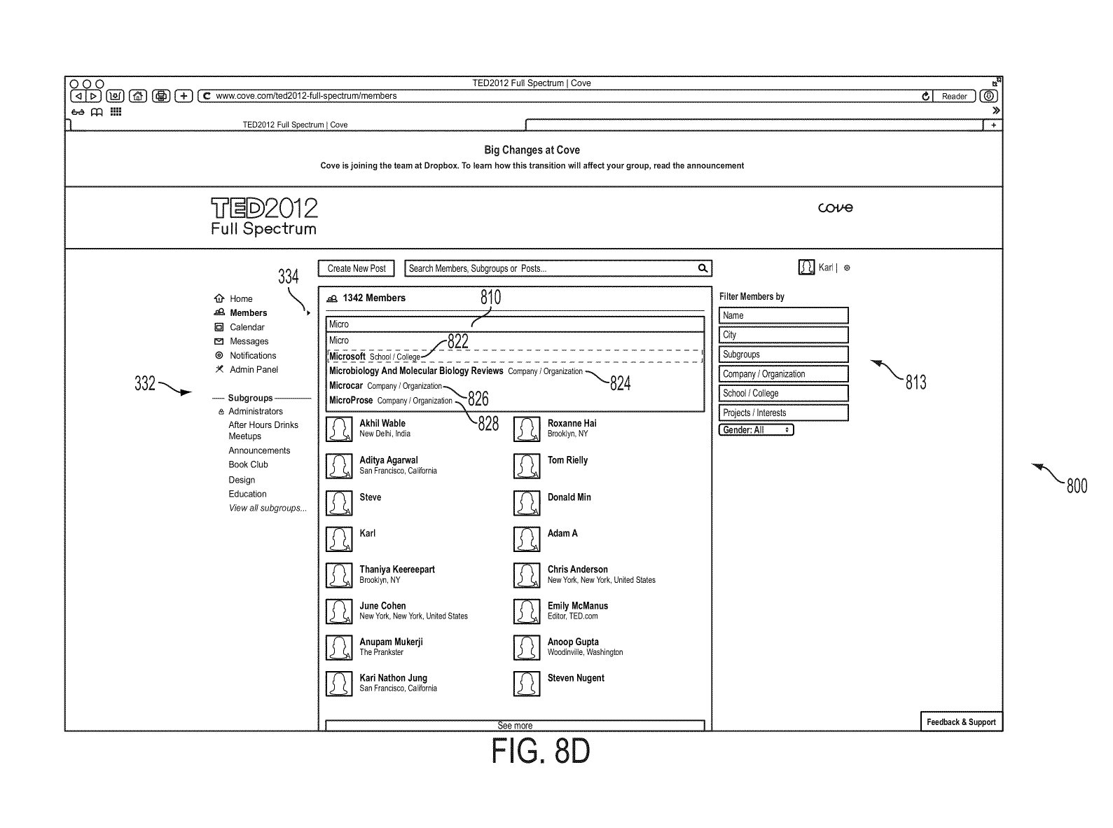

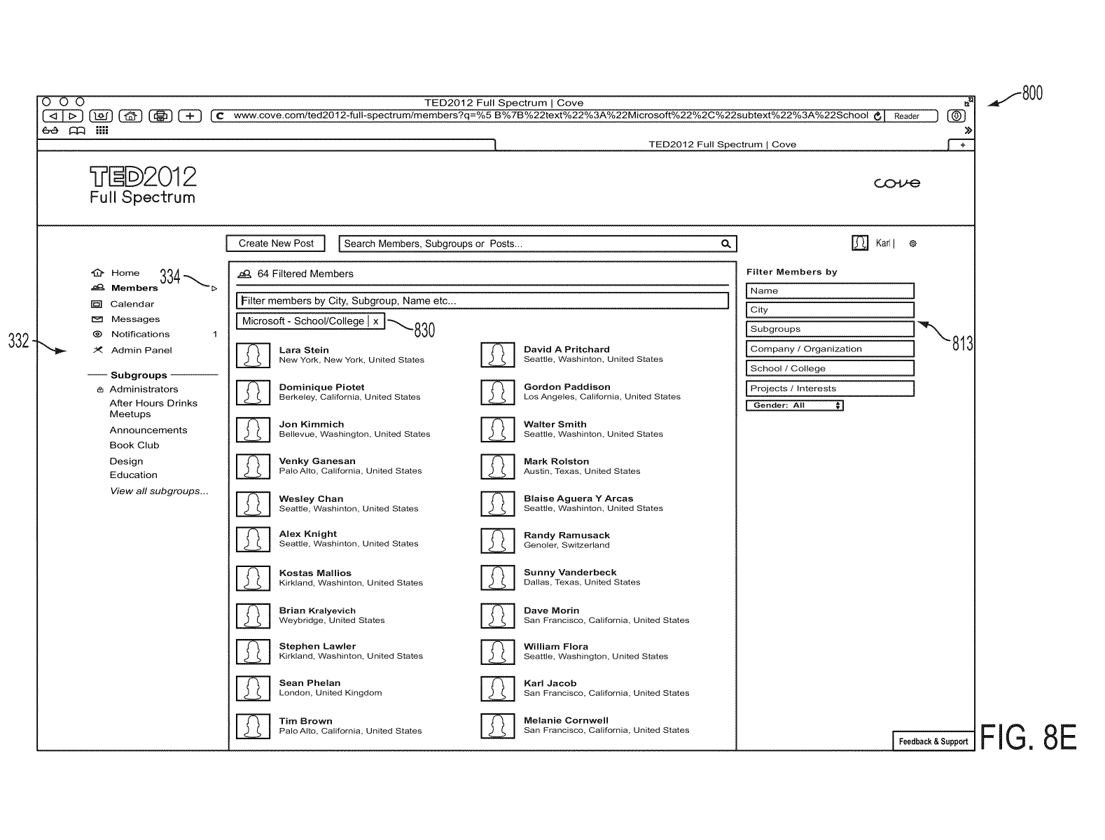

FIG. 11 shows exemplary methods for searching for a subset of members. Beginning at step 1100, system 100 may receive a search term from a user. The search term, in various embodiments, may be a name, a city, a college, or any other suitable search criteria. In various embodiments, the search term may be entered into search box 810 (FIG. 8A). At step 1102, system 100 may search one or more data sets for a plurality of suggested search terms that contain the received search term and is associated with one or more system-designated facets. As mentioned above, the data set could be internal to the system, from Freebase, or from any suitable database.

At step 1104, system 100 may rank the suggested search term-facet combinations based on the number of times each suggested search term-facet combination appears in the data set. In other embodiments, the system may rank the search term-facet combinations by the number of times the search term-facet combination appears in other databases or websites, or the number of times the search term-facet combination has been searched by others, or by any other suitable means. At step 1106, the system may be configured to display each of the plurality of suggested search terms and the associated one or more system-designated facets as suggested search term-facet combinations. In various embodiments, the system may display the suggested search term-facet combinations by rank or by any other acceptable means. In several embodiments, the system may display the top four ranked search term-facet combinations.

At step 1108, system 100 may allow the user to select the suggested search term-facet combination by any acceptable means. For example, a user may click on the desired search term-facet combination or highlight the desired search term-facet combination and hit enter on a keyboard. At step 1110, in response to the user selecting the suggested search term-facet combination, the system may initiate a search of a second data set based on the selected search term-facet combination. In various embodiments, the second data set search may be of the same data set at the first search. In other words, in several embodiments, the user may further refine the search to a smaller subset of data.

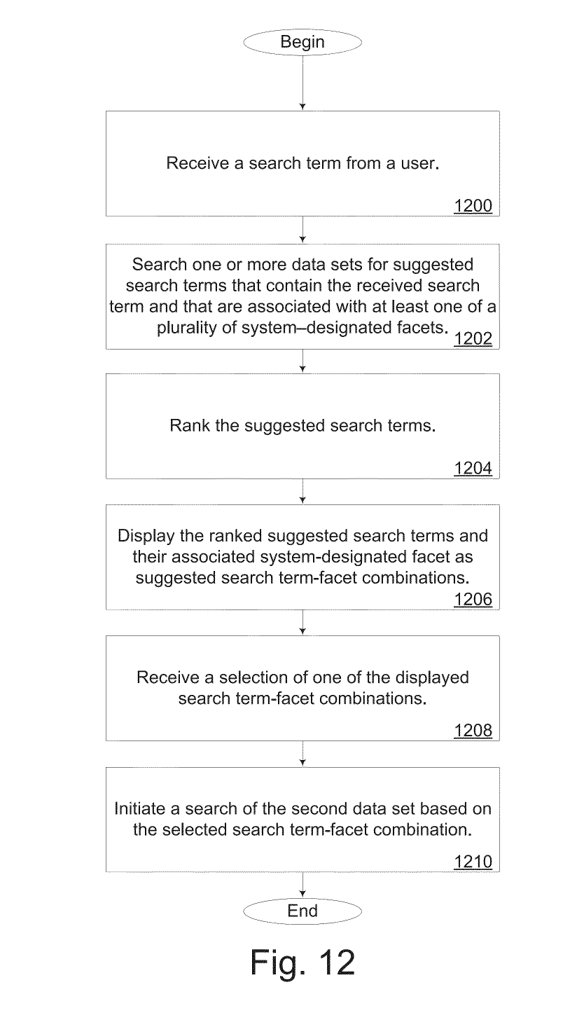

FIG. 12 shows yet another embodiment of a search methodology. Beginning at step 1200, system 100 may be configured to receive a search term from a user. The search term, in various embodiments, may be a name, a city, a college, or any other suitable search criteria. In various embodiments, the search term may be entered into search box 810 (FIG. 8A). At step 1202, the system searches one or more data sets for suggested search terms that contain the received search term and that are associated with one or more of a plurality of system-designated facets. As mentioned above, the data set(s) could be internal to the system and/or from any suitable database. Additionally, the system-designated facets may be based on the preferences or profile of the searcher or any other suitable facet.

At step 1204, system 100 may rank the suggested search terms. In several embodiments, the suggested search terms may be ranked based on the number of times each suggested search term-facet appears in the data set. In other embodiments, the system may rank the search terms by the number of times the search term appears in other databases or websites, or the number of times the search term has been searched by others, or by any other suitable means. At step 1306, system 100 displays, to the user, the ranked suggested search terms and their associated system-designated facet as suggested search term-facet combinations. In various embodiments, the system may display the suggested search terms by rank or by any other acceptable means. In several embodiments, the system may display the top four ranked search terms.

At step 1208, system 100 may receive, from the user, a selection of one of the displayed search term-facet combinations. For example, a user may click on the desired search term-facet combination or highlight the desired search term-facet combination and hit enter on a keyboard. At step 1210, system 100 may initiate a search of the second data set based on the selected search term-facet combination. In various embodiments, the second data base search may be of the same data set at the first search. In other words, in several embodiments, the user may further refine the search to a smaller subset of data.

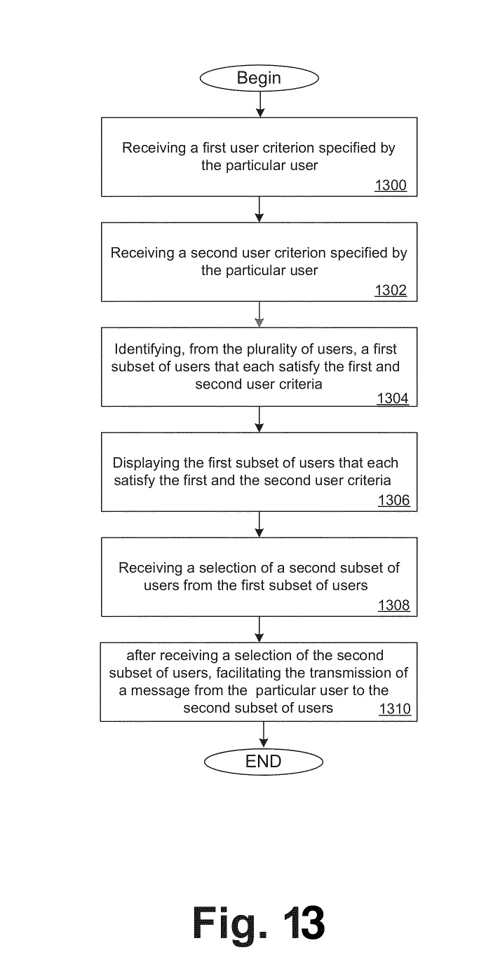

FIG. 13 shows a particular embodiment of an implementation of the search methodology of FIGS. 11 and 12 applied to a social networking site where a particular user of the social networking site wishes to find other users with similar interests. The system is also configured to allow the user to select a subset of the found users and to communicate with the subset of users. Beginning at step 1300, content management system 100 receives a first user criterion that may be specified by a particular user. The first user criterion, in various embodiments, may be a search term, such as a name, a city, a college or any other suitable search criteria. In various embodiments, the first criterion may be entered into search box 810 (FIG. 8A). At step 1302, content management system 100 may receive a second user criterion that may be specified by the particular user. The second user criterion, similar to the first criterion, may be a second search term. At step 1304, content management system 100 identifies, from the plurality of users on the content management system a first subset of users that have one or more profiles that contain the first and second criteria. At step 1306, the system may be configured to display the first subset of users. The display of the first subset of users may only include a name of each user and a picture of the user. In other embodiments, the display of the first subset of users may include the name, a picture and at least a portion of the user's profile.

At step 1308, the system receives, from the particular user, a selection of a second subset of users from the first subset of users. In various embodiments, the particular user may be allowed to select one or more of the users from among the displayed second subset of users. In various embodiments, a selection box or button may be displayed adjacent each user of the second subset. In other embodiments, system 100 may be configured to highlight each selected user when the particular user clicks on a displayed user's picture. In certain embodiments, the system may be configured to allow the particular user to select one or more of the users of the second subset of users. At step 1310, after receiving a selection of the second subset of users, the system facilitates the transmission of a message from the particular user to the second subset of users. In some embodiments, the message may be an e-mail, and in other embodiments, the message may be a wall posting, a text message, an instant message, or any other suitable type of communication that transmits a voice, text, or other data communication.

In various embodiments, the system may receive the first user criterion and identify one or more users that have one or more group profiles that satisfy the first criterion. In these embodiments, the system may then display the one or more users to the particular user. The system may then receive the second user criterion from the particular user. Once again, system 100 may then identify a first subset of users, from the one or more user, who have one or more profiles that contain both the first and second criteria. Once the first subset of members is identified, the system may display the first subset of members. The system may then receive a selection of a second subset of users from the first subset of users. After receiving the selection of the second subset of users, the system may facilitate the transmission of a message from the particular user to the second subset of user.

### Exemplary User Experiences

The operations of exemplary embodiments of the system are perhaps best understood by reviewing particular examples. The following examples describe an exemplary experience of a group member.

Exemplary User Pages

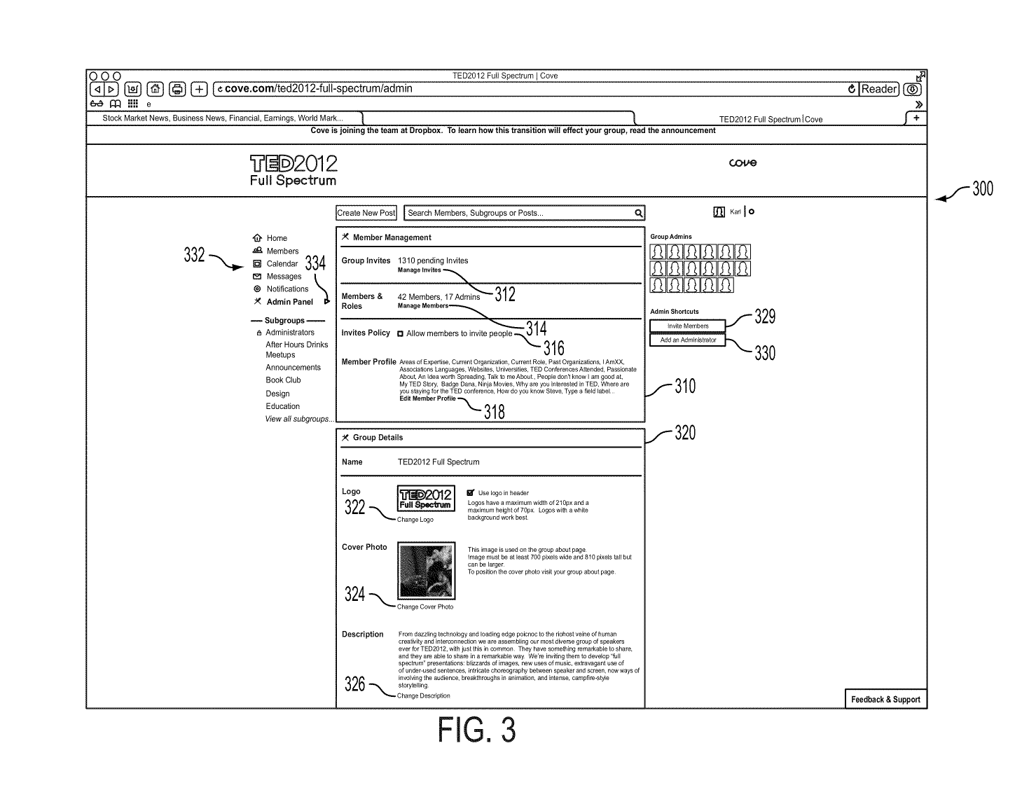

An exemplary user interface for a particular social networking site according to a particular embodiment is shown in FIGS. 3-13. FIG. 3 illustrates Member Management section 300 of Administration Panel 302 for a TED2012 user group. This page may be initially displayed to a user (in this case a user with administrator rights) when the user sets up a new group on content management system 100. This page includes, for example, Member Management section 310 and Group Details section 320. Member Management section 310 may allow the administrator of the group to manage invitees by selecting “manage invites” link 312, change the roles served by the group's members (e.g., provide members with administrator rights) by selecting “manage members” link 314, change the group's invitee policy by selecting “allow members to invite people” check box 316, and edit the group's member profile requirements by selecting “edit member profile” link 318. Group Details section 320 may allow the administrator to enter and display information about the group. For example, in various embodiments, the group administrator may be granted the ability to add or change the group's logo by selecting “change logo” link 322, add or change the group's cover photo by selecting “change cover photo” link 324, and add or edit the description of the group by selecting “change description” link 326. This page may also enable administrators to invite new members to the group by selecting “invite members” button 329 and to add new administrators to the group by selecting “add an administrator” button 330. Navigation panel 332 may be positioned on a side of the page and allow the administrator and members of the group to navigate to different pages associated with the group. Navigation panel 332 may be displayed on each page and provides indicator 334 that notifies the user which page is active.

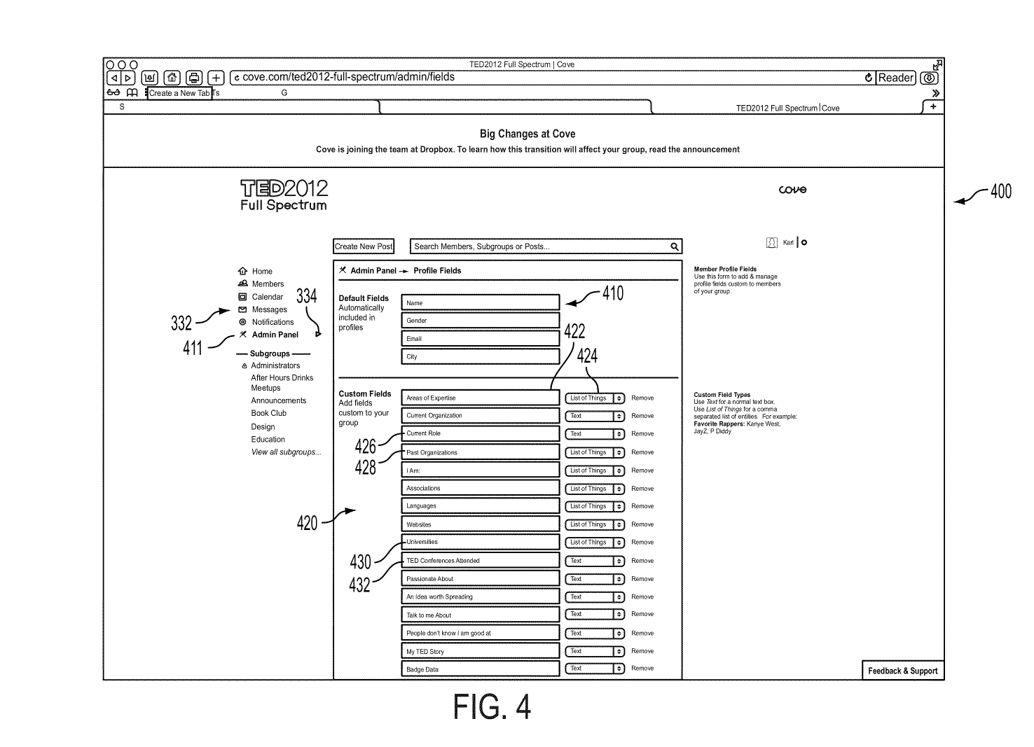

FIG. 4 illustrates Edit Profile Fields 400 page. Edit Profile Fields page 400 may display default fields 410 for the member profile for a particular group and enable an administrator or a member with administrator rights to add custom fields 420 to the group's member profile, or to remove custom fields from the profile. In various embodiments, default fields 410 may be fields that are common to every user group and that may, for example, be pre-populated when a new invitee creates a profile for a particular group. In various embodiments, default fields may include the invitee's name, gender, e-mail address, city of residence and any other suitable member information that would be the same across all groups.

In various embodiments, custom fields 420 may be administrator-defined fields that are specific to the group. For example, for a TED2012 conference group, group-specific fields may include: (1) area of expertise field 422; (2) current organization field 424; (3) current role field 426; (4) past organization field 428; (5) universities field 430; (6) TED conferences attended field 432; and (7) other suitable fields that are related to the TED2012 conference group. The administrator-defined fields may allow the group administrator to build a member profile template that best fits the purpose of the group and that provides searchable information for finding members.

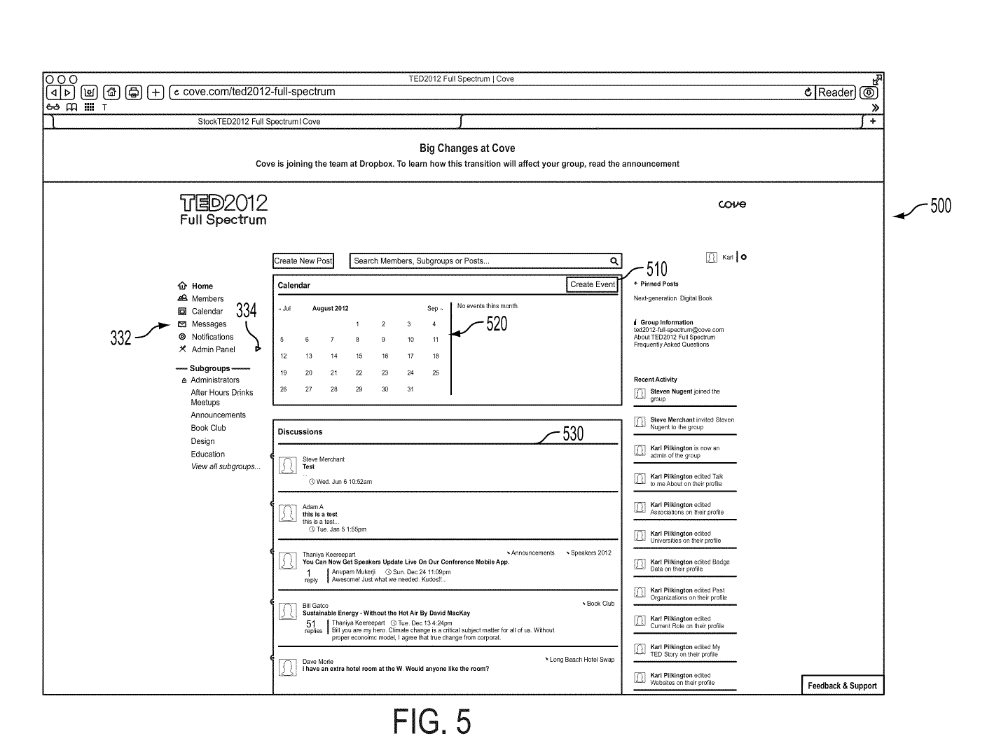

FIG. 5 illustrates Home page 500 for the TED2012 group. This page may: (1) contain create event button 510 that enables the group's members to create events for the group; (2) display calendar 520 that displays events related to the group; and (3) provide discussions post section 530 that lists entries created by the group's members.

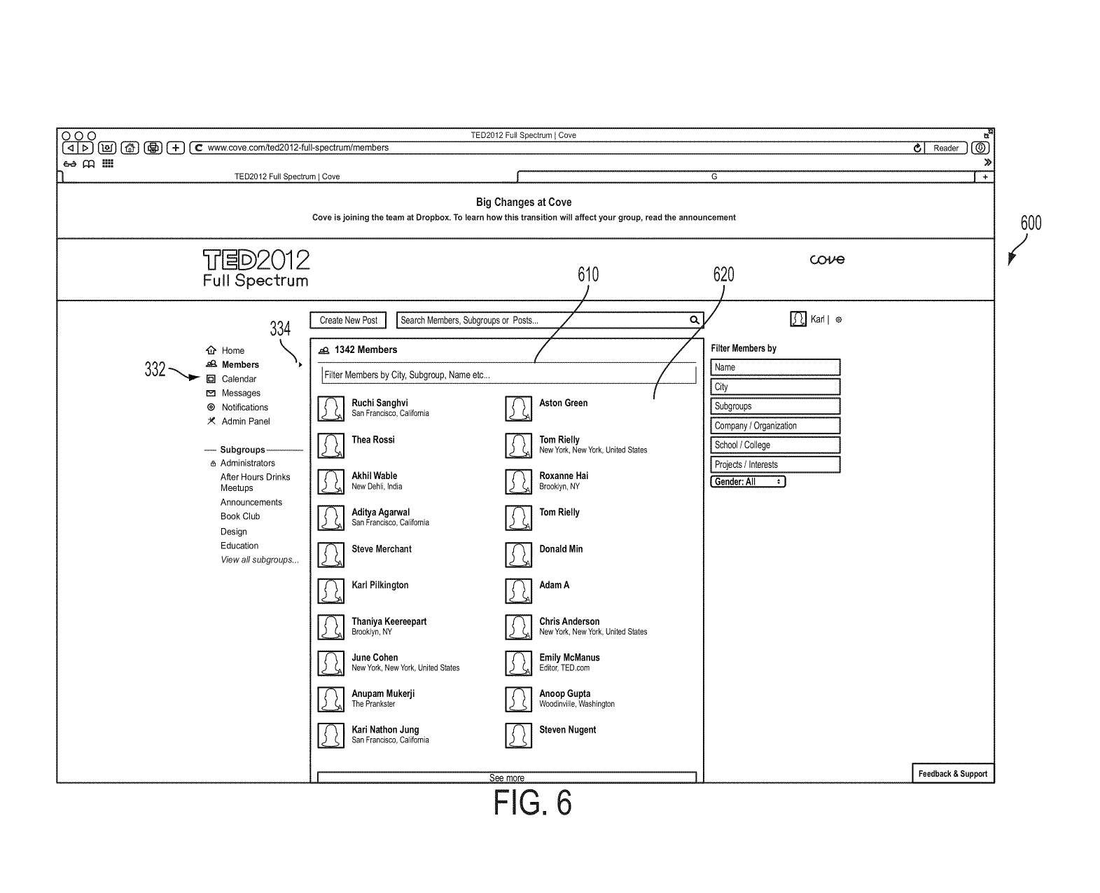

FIG. 6 illustrates Members page 600 according to a particular embodiment. This page may include search field 610 for filtering group members and display listing 620 of all members within a group. In various embodiments, members may be allowed to use this page to perform a free text search using search field 610 to filter the listed members, as well as create new posts that are listed in discussion post section 530 (FIG. 5).

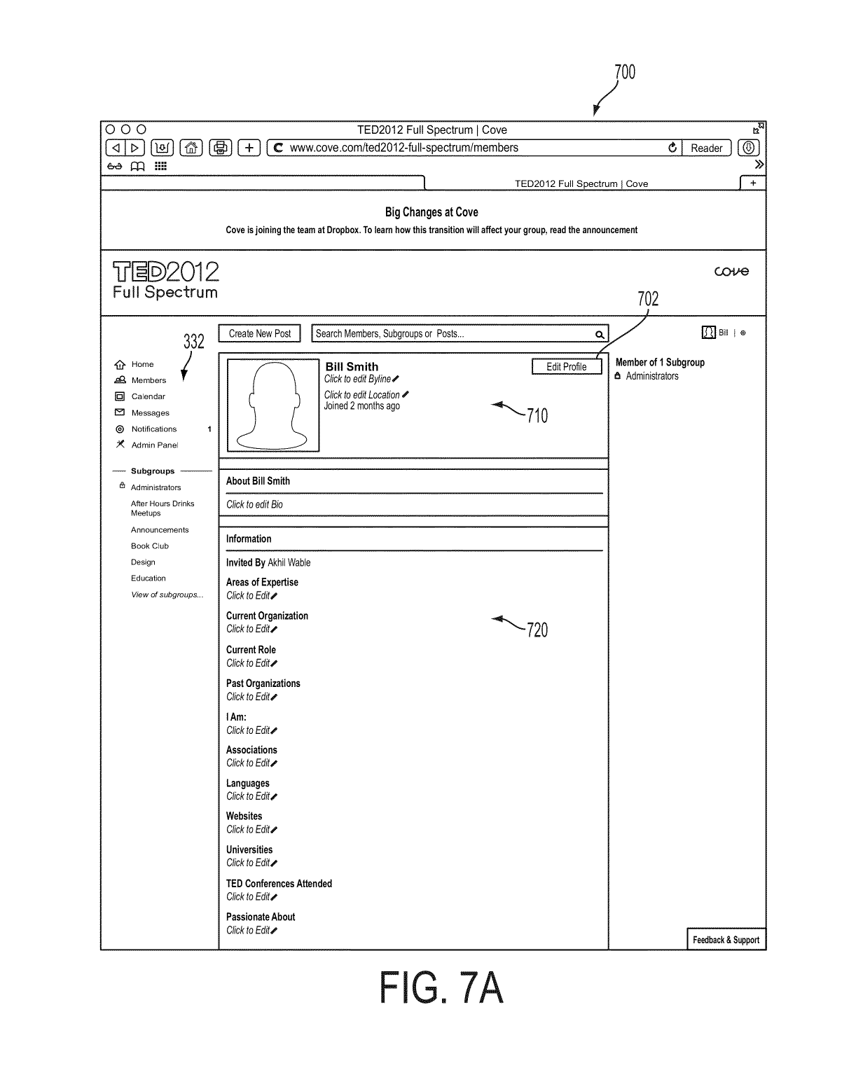

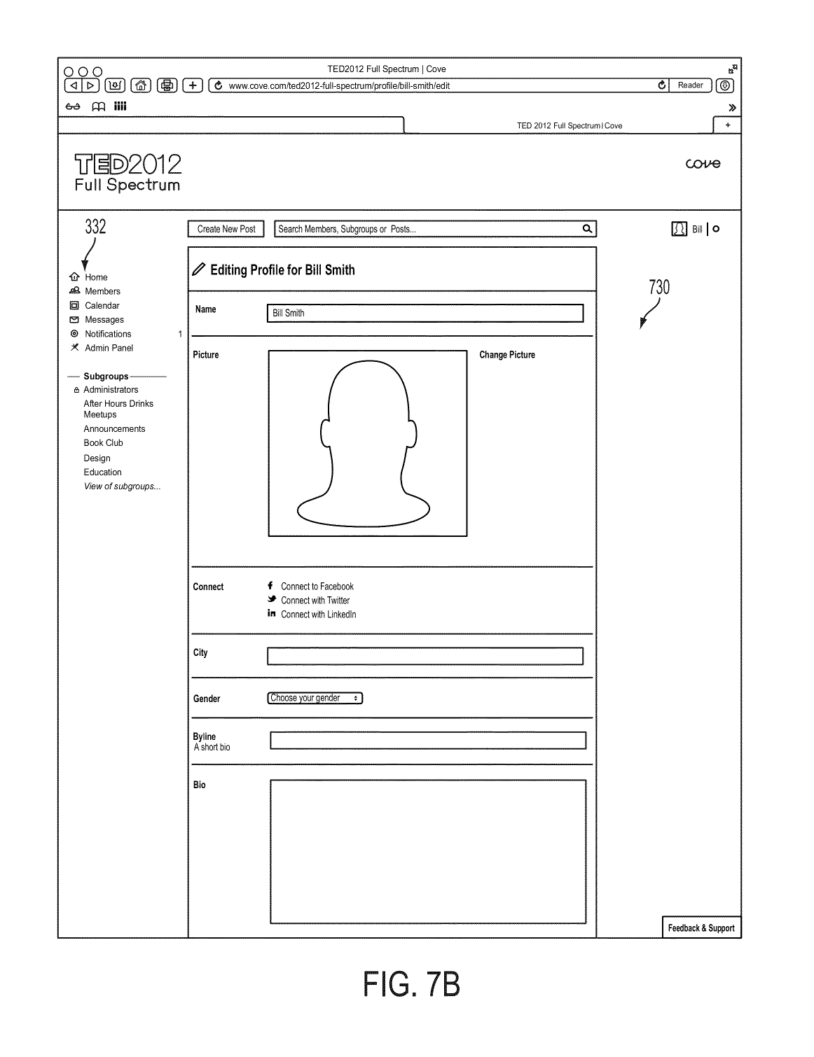

FIG. 7A illustrates Member Profile page 700. As may be understood from this figure, Member Profile page 700 may include a default member profile section 710 and custom member profile section 720. Default member profile section 710 may reflect default fields 410 in the member profile template of FIG. 4. In various embodiments, the system may auto-populate the fields since these are based on information that the user entered when joining the social networking site. Custom member profile section 720 may correspond to custom fields 420 in the member profile template of FIG. 4. In various embodiments, the user may be allowed to select individual fields to edit, or select a “edit profile” link 702, which brings the user to Profile page 730 illustrated in FIG. 7B. Profile page 730 may allow the user to edit all fields in their profile. In this way, the user may be allowed to tab from field-to-field entering data to create their group-specific profile.

FIGS. 8A-8E, 9, and 10 collectively demonstrate a search process available in conjunction with various embodiments of the social networking site. The search process may allow the user to enter search 811 into search box 810, and the system may automatically generate a list of suggested search term/facet combinations that the user may select, at any time, to filter the list of members displayed below the search box. In various embodiments, the system may not alter the current displayed list of members until the user either selects one of the proposed search term/facet combinations, or presses the “enter” button. The system may provide the list of suggested search term/facet combinations by searching one or more databases for the search term in combination with one or more non-user specified facets. A facet may correspond to one of the fields in the member profile template.

Once the system identifies search results in the one or more databases that are associated with the non-user specified facets, the system may rank the results to determine which of the results should be displayed to the user as suggested search term/facet combinations. In various embodiments, the system may rank the results by counting the number of times the search term/facet combination is found in the databases. The system may then display the four highest ranked search term/facet combinations.

In various embodiments, the system may search one or more databases that contain member profile data. In other embodiments, the system may search the profile databases in combination with a collaborative knowledge database that is built on structured data harvested from many sources, including individual wiki contributions. One such suitable database is Freebase, provided by Google, Inc. In some embodiments, the system may make a data call to the Freebase database using an API, and in various other embodiments, the Freebase database may be downloaded and stored locally on the system. It should be understood from reference to this disclosure that other suitable ranking systems may be used with the present search methodology.

The above described search methodology may be advantageous when a user wants to search for a single term against data associated with multiple facets. That is, the present system may allow a user to enter a single search term in one location, instead of having to enter the term in more than one location or using a complicated search string. Moreover, the user does not need to take the extra step of specifying a particular facet for the search since the system will conduct the search in data categories associated with all of the non-user specified facets. In alternative embodiments, the user could perform a traditional facet search by entering the search term in one of search boxes 813 (FIGS. 8A-8E) that are associated with a respective facet. If the user performs a traditional facet search, the system may only search the database for profiles that contain the search term with the associated facet. In other embodiments, if the user presses the enter button without selecting a particular system suggested search term/facet combination, the system may display a list of all members whose profile contains the search term in any of the non-user specified facet categories.

Search Experience

The following discussion provides a brief example of a search in accordance with the search methodology described above. Referring once again to FIG. 6, search box 610 allows a member to search for other members that have common interests. For example, the member of the group may want to find all members that attended the “Microsoft” college. Thus, the member may conduct a search by typing in a free-text word (e.g., “Microsoft”) to see all members whose profile lists “Microsoft” as a college/university.

Returning to the example and referring to FIG. 8A, a member would like to identify other members of the TED2012 group who attended the Microsoft School and lives in his city. In Search field 810 on Members page 800, the member begins typing the letter “M”. System 100 may begin to display a list of suggested search term that begin with the letter “M” and that are associated with one or more system-designated facets. As described above, the system may search one or more databases for all data that begins with the letter “M” and that is associated with one of the system-designated facets. The system may then rank the results and display the four highest ranked results. Thus, for example and still referring to FIG. 8A, names “Donald Min” 812, and “Anupam Mukerji” 814 are returned in addition to two other names. Referring to FIG. 8B, as the member adds additional letters to the search term (e.g., “M”, “I” and “C”), the system may return new suggested search terms that begin with the letters “M”, “I” and “C”. In this example, one name returned is “Michael” 816, which refers to all members having the name “Michael” and the name “Michelangelo Volpi” 818.

As the member continues to develop the search by adding additional letters to the search term (e.g., by typing “R” and “O” after “MIC”), the system may (1) identify search terms that begin with the letters “MICRO” in combination with the system-specified facets, (2) rank the results based on the number of times the terms appear in the one or more databases being searched, and (3) display the four highest ranked search term/facet combinations. Referring to FIG. 8C, the system may provide the highest ranked results as follows:

| Search Term | Facet |
|---|---|
| Microsoft - 822 | school/college |
| Microbiology and Molecular Biology | company/organization |
| Reviews - 824 | |
| Microcar - 826 | company/organization |
| Microprose - 828 | company/organization |

As illustrated in FIG. 8D, the member may select the search term/facet combination “Microsoft—School/College” because he is searching for group members that attended “Microsoft” the school. Referring to FIG. 8E, the system may display a list of members who specified Microsoft as their “School/College”. Moreover, button 830 displaying “Microsoft—School/College” may appear below search box 810. Button 830 provides an indication to the member that the member list has been filtered by the term/facet “Microsoft—School/College.” Should the member wish to remove this filter, in various embodiments, he may click on button 830 to remove the “Microsoft” filter.

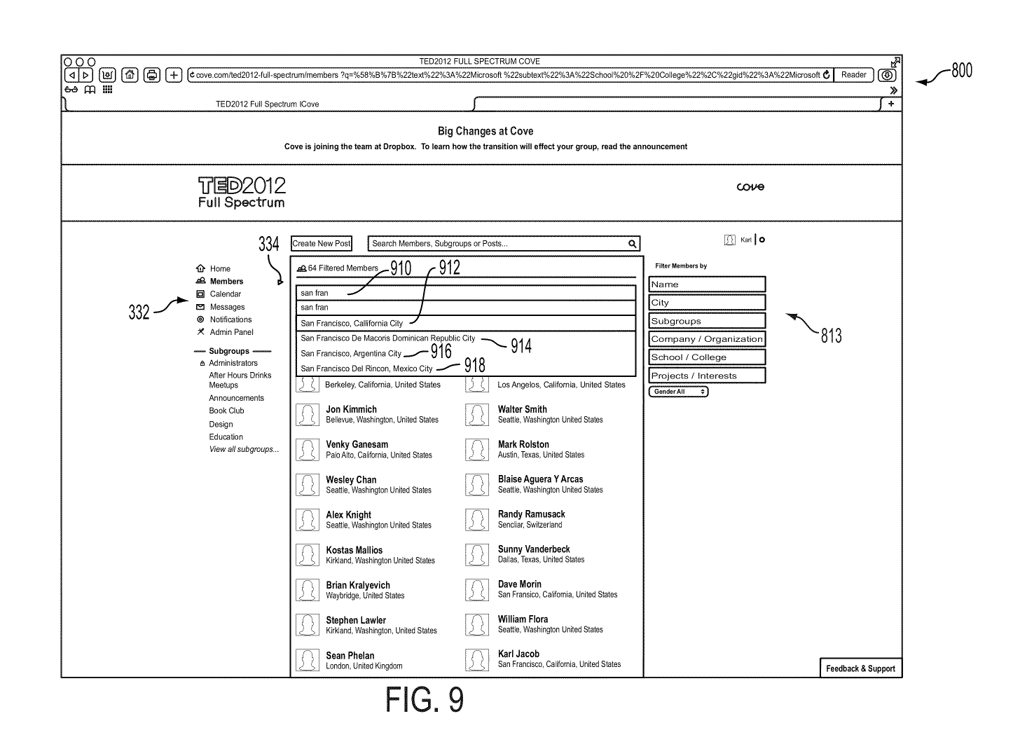

At this point, the member may like to know if any of the members who attended Microsoft the school are also located in San Francisco, Calif. Thus, referring to FIG. 9, the member can begin typing the letters “San Fran” in a search field 910, which returns various suggested search term/facet combinations such as:

| Search Term | Facet |
|---|---|
| San Francisco, California - 912 | City |
| San Francisco De Macoris, Dominican Republic - 914 | City |
| San Francisco, Argentina - 916 | City |
| San Francisco Del Rincon, Mexico - 918 | City |

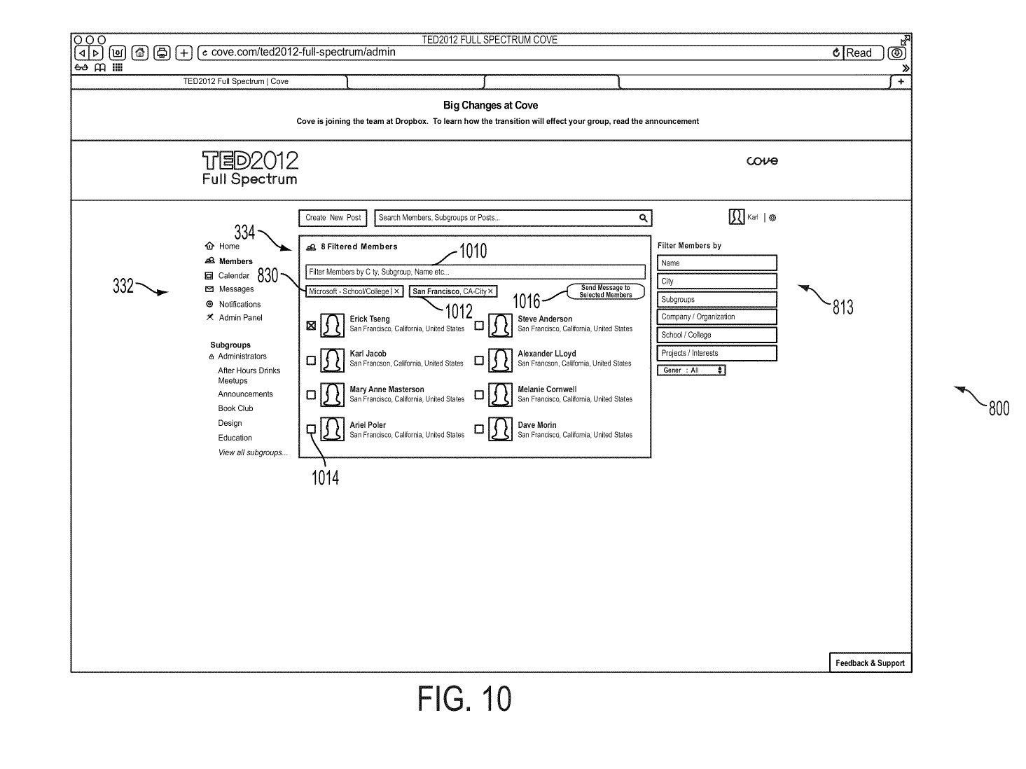

In this example, the highest ranked search term/facet combinations all contain the facet “city”. The member may click “San Francisco, Calif.—City” since he is looking for members who attended Microsoft the school and who also live in the city of San Francisco, Calif. Referring to FIG. 10, when “San Francisco, Calif.—City” is selected, another filter indication button 1012 may appear adjacent button 830, this one displaying “San Francisco, Calif.—City.” Moreover, the member list may be filtered even further to display only TED2012 members who live in San Francisco and who attended Microsoft the school. The member may now be able direct messages through e-mail, a wall post, instant message, through an invite or any other suitable communication means to specific members that meet this search criteria by checking selection box 1014 next to each member, and by clicking “send message to selected members” button 1016. In various embodiments, the selection boxes may not be used. Instead, a message may be sent to all of the members of the filtered result by clicking “send message to selected members” button 1016. In other embodiments, other means may be used to individually select members to include in a private communication. For example, clicking on a member may highlight that member, where the member can select one or members to include in the communication. Thus, the system may provide an efficient means for searching for members that meet one or more specific criteria and facilitating a communication to a selected subgroup of those members.

### CONCLUSION

Many modifications and other embodiments of the invention will come to mind to one skilled in the art to which this invention pertains having the benefit of the teachings presented in the foregoing descriptions and the associated drawings. It should also be understood that, although various embodiments are described above as using a structured database, any other suitable data structure can be used to allow for free-text searches.

In light of the above, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer-implemented method of performing a search of a data set, the method comprising:
receiving a search term from a user;
searching, by at least one processor, at least one data set for at least one suggested search term that contains the received search term and that is associated with one or more system-designated facets;
displaying, to the user, the at least one suggested search term and the associated one or more system-designated facets as suggested search term-facet combinations;
allowing the user to select the suggested search term-facet combination;
in response to the user selecting the suggested search term-facet combination, initiating a search of a second data set based on the selected search term-facet combination.

2. The computer-implemented method of claim 1, wherein:
searching the at least one data set further comprises searching the data set for a plurality of suggested search terms that contain the received search term and that are associated with the one or more system-designated facets; and
displaying further comprises displaying, to the user, each of the plurality of suggested search terms and its associated one or more system-designated facets as suggested search term-facet combinations.

3. The computer-implemented method of claim 2, further comprising ranking the suggested search term-facet combinations based on the number of times each suggested search term-facet combination appears in the data set.

4. The computer-implemented method of claim 3, wherein the step of displaying further comprises displaying the four highest ranked search term-facet combinations to the user.

5. The computer-implemented method of claim 1, further comprising receiving, from the user, a selection of one of the displayed search term-facet combinations.

6. The computer-implemented method of claim 1, wherein
the second data set is a database that contains member profiles for a social networking site;
each entry of the member profile database contains a plurality of information for a member of the social networking site; and
each one of the plurality of information for the member is associated with one of the one or more system-designated facets.

7. The computer-implemented method of claim 6, further comprising displaying a list of members whose member profile contains the selected suggested search term-facet combination.

8. The computer-implemented method of claim 1, wherein the at least one data set is the second data set.

9. The computer-implemented method of claim 1, wherein the second data set is a data set associated with a synched content management system.

10. A computer system for performing a search of a data set comprising:
at least one processor;
memory operatively coupled to the at least one processor; and
a second data set stored in the memory,
wherein the at least one processor is configured to:
receive a search term from a user;
search one or more data sets that are operatively coupled to the at least one processor for suggested search terms that contain the received search term and that are associated with at least one of a plurality of system-designated facets;
rank the suggested search terms;
display, to the user, the ranked suggested search terms and their associated system-designated facet as suggested search term-facet combinations;
receive, from the user, a selection of one of the displayed search term-facet combinations; and
initiate a search of the second data set based on the selected search term-facet combination.

11. The computer system of claim 10, wherein the second data set is a member profile database for a social networking site.

12. The computer implemented system of claim 10, wherein the second data set is data associated with a synched content management system.

13. The computer system of claim 12, wherein the at least one processor is further configured to display all members whose member profile contains the selected search term-facet combination.

14. The computer system of claim 11, wherein the at least one processor is further configured to use the number of times the suggested search terms appear in the one or more data sets to rank the suggested search term-facet combinations.

15. A system of performing a search, the system comprising:
at least one processor; and
a display operatively coupled to the at least one processor,
wherein the at least one processor is configured to:
receive a search term from a user;
search one or more data sets operatively coupled to the at least one processor for entries that contain the received search term and that are associated with one of a plurality of system-designated facets;
form a suggested search term-facet combination by pairing each entry that contains the received search term with the system-designated facet that is associated with the entry;
display, to the user, the suggested search term-facet combinations; and
initiate a search of a second data set that is operatively coupled to the at least one processor based on a selected one of the displayed search term-facet combinations.

16. The system of claim 15, wherein
the one or more data sets is one or more databases;
the second data set is a member profile database that contains a plurality of entries, each entry corresponding to a member profile;
each of the plurality of entries comprises a plurality data points; and
each one of plurality of data points is associated with a respective system-designated facet.

17. The system of claim 16, wherein the at least one processor is further configured to display, to the user, each member profile that contains the selected search term-facet combination.

18. The system of claim 15, wherein the at least one processor is further configured to rank each suggested search term-facet combination based on the number of times each one of the suggested search terms appears in the one or more data sets.

19. The system of claim 18, wherein displaying the suggested search term-facet combinations further comprises displaying the four highest ranked search term-facet combinations.

20. A system of performing a search, the system comprising:
a means for receiving a search term;
a means for determining a plurality of search term-facet combinations based on the received search term and a plurality of system-designated facets;
a means for searching a data set based on a selected one of the search term-facet combination; and
a means for selecting and displaying data from a data set based on one of the search term-facet combinations.

21. The system of claim 20, wherein the data set is a database that comprises profile information for members of a social networking site.

22. The system of claim 20, the means for determining a plurality of search term-facet combinations further comprises:
a means for searching one or more data sets for data that is based on the received search term; and
a means for associating the data with one of the plurality of system-designated facets.
